(19) United States
(12) Patent Application Publication
(10) Pub. No.: US 2023/0266538 A1
(43) Pub. Date: Aug. 24, 2023

(54) Tool and Method for Producing a Lamp Body

(71) Applicant: Bayerische Motoren Werke Aktiengesellschaft, Muenchen (DE)

(72) Inventors: Martin LOBENZ, Ergoldsbach (DE); Franz MAIDL, Eichendorf (DE); Chris MOOSMUELLER, Niederaichbach (DE); Fabian SEYBOLD, Vilsbiburg (DE)

(21) Appl. No.: 18/017,553

(22) PCT Filed: Jul. 28, 2021
(86) PCT No.: PCT/EP2021/071111

§ 371 Date: Jan. 23, 2023

(30) Foreign Application Priority Data
Sep. 14, 2020 (DE) 10 2020 123 856.8

(51) Int. Cl. G02B 6/36; F21V 8/00; G02B 6/46

(52) U.S. Cl. CPC G02B 6/3612; G02B 6/001; G02B 6/46

(57) ABSTRACT

A tool for producing a lamp body includes a tool head having an optical waveguide exit opening, an optical waveguide provision device for providing an optical waveguide at the optical waveguide exit opening, and a positioning element which has an optical waveguide guide surface and is displaceable along an axis that extends at a distance from the optical waveguide exit opening.

### BACKGROUND AND SUMMARY OF THE INVENTION

The invention relates to a tool and a method for producing a lamp body.

By the use of optical waveguides in vehicle lamps, it is possible to provide complexly shaped lamp bodies that allow the implementation of futuristic and novel lighting effects. Innovative lighting concepts in vehicles provide inter alia three-dimensional light sculptures in which one or more optical waveguides are arranged in a spatial structure to form a lamp body and are made to shine by light coupled in. The optical waveguides are in this case fastened on a supporting structure which defines the spatial shape of the light sculpture.

Against this background, it is an object of the invention to present a way in which lamp bodies obtained by using an optical waveguide may be provided economically. invention.

The object is achieved by a tool and by a method according to the claimed invention.

A tool for producing a lamp body is specified. The tool contains a tool head with an optical waveguide exit opening as well as an optical waveguide provision device for providing an optical waveguide at the optical waveguide exit opening.

An optical waveguide is in the present case a medium in the form of a cable or line, which guides light coupled in by a light source along its lengthwise extent. This may, in particular, be achieved by light coupled in being reflected at the interface of the optical waveguide with the surrounding medium. Preferably, the optical waveguide is a side-emitting optical waveguide which couples light out from the optical waveguide in a controlled way along its longitudinal extent. For this purpose, for example, defects may be introduced on the surface (for example by structuring, roughening, applying optical surfaces, or the like) or in the material (for example cavities, impurities). The optical waveguide is preferably provided as an endless material, for example on a roll.

With the optical waveguide provision device, the optical waveguide is guided as far as the tool head, where it emerges from the optical waveguide exit opening. For this purpose, the optical waveguide provision device may for example contain a plurality of guide elements or deflecting rolls. The optical waveguide may be drawn off at the optical waveguide exit opening, the optical waveguide provision device being configured to keep the optical waveguide under a pretension so that a minimal force is needed for drawing off the optical waveguide. This ensures that the optical waveguide is kept in the tensioned state when it is guided from one reception groove to the next reception groove.

The tool furthermore comprises a positioning element with an optical waveguide guide surface. The positioning element can be displaced along an axis, which extends at a distance from the optical waveguide exit opening. The positioning element may, for example, be configured as a hydraulic or pneumatic cylinder. Because of the displaceability, a distance between the optical waveguide exit opening and the optical waveguide guide surface may be varied. The positioning element may thereby be inserted into the profile which the optical waveguide assumes from the reception groove approached last as far as the tool. The optical waveguide guide surface may be brought in contact with the optical waveguide and represents a third point in the profile of the optical waveguide. By further displacement of the positioning element, the angle at which the optical waveguide extends may be varied, and in particular a section of the optical waveguide may be aligned in a predetermined setting relative to a reception groove, in such a way that it can be placed particularly easily in this reception groove. The tool is, in particular, suitable for carrying out the method described below.

A method for producing a lamp body is specified. The lamp body contains a carrying structure, along which an optical waveguide is guided and fastened. The optical waveguide may, in particular, have a complex three-dimensional profile with a plurality of direction changes on the carrying structure. The method comprises the following steps:
providing a carrying structure having reception grooves, and
winding an optical waveguide around the carrying structure, for which purpose it is placed successively in the reception grooves by way of a tool according to a planned optical waveguide profile.

According to embodiments of the invention, the placement in the reception grooves comprises the following steps:
tensioning the optical waveguide between the reception groove approached last and an optical waveguide exit opening of the tool,
introducing a positioning element into the path of the optical waveguide, and displacing the optical waveguide in such a way that an optical waveguide section that is arranged between the positioning element and the optical waveguide exit opening is aligned in a predetermined setting relative to a reception groove, and
placing the optical waveguide section in the reception groove by moving the positioning element and the optical waveguide delivery opening while maintaining their relative setting with respect to one another, and
removing the positioning element from the optical waveguide.

This may be repeated until the optical waveguide has been wound in the desired shape on the carrying structure.

The carrying structure comprises a plurality of reception grooves, which preferably lie in a plurality of planes. The optical waveguide is placed in a plurality or all of these reception grooves. For this purpose, the optical waveguide is guided on a predetermined optical waveguide profile along the carrying structure or around the latter, and preferably forms a three-dimensional sculpture.

The method is now based on the concept that rapid placement of the optical waveguide in the reception grooves may be carried out reliably, and above all independently of the position of the reception groove approached last, if the optical waveguide section that has been placed is already aligned in a predetermined setting with respect to the reception groove before placement in the latter. For example, the optical waveguide section may be arranged substantially parallel to the longitudinal profile of the next reception groove to be approached. “Substantially parallel” is in this case intended to mean that the optical waveguide section is inclined by not more than 10 degrees, and preferably not more than 5 degrees, in relation to the longitudinal profile of the reception groove. By matching the profile of the optical waveguide to the alignment of the groove, the optical waveguide may then also be placed reliably in the groove if the reception groove is used as a kind of deflection point and the optical waveguide that has been placed experiences a significant direction change at this point. This has the advantage that the alignment of the reception grooves may be made independent of the subsequent optical waveguide profile. In this way, it is possible to produce different light sculptures with a single carrying structure geometry.

For economical manufacturing which is compatible with mass production, it is particularly advantageous that in one configuration the method may be carried out in an automated fashion. For this purpose, the tool head may be arranged on a multiaxial industrial robot, and moved and positioned by the latter.

So that, during the forward movement of the positioning element, the optical waveguide may be securely gripped and approached to the optical waveguide guide surface, in one configuration it is advantageous that the positioning element is configured at its free end in the shape of a fork with two guide bars, between which the optical waveguide guide surface is arranged. The guide bars may for example be aligned parallel to one another or jut out from the optical waveguide guide surface.

In order to ensure great flexibility in respect of the guiding of the optical waveguide and to be able to contact and position the latter reliably with the positioning element, in one configuration it is advantageous that the positioning element is also configured to be rotatable about the axis along which it is displaceable. In this way, the positioning element may be brought into an optimal position according to the profile of the optical waveguide, in order to grip the latter. In particular, the guide bars may therefore be aligned in accordance with the profile of the optical waveguide.

At the tool head, the optical waveguide emerges from the optical waveguide exit opening. In one configuration, it is arranged at the free end of a finger-shaped element. The finger-shaped element ensures good accessibility even to angled or complexly shaped carrying structures.

Features and details which are described in connection with the tool also apply in connection with the method according to embodiments of the invention, and vice versa, so that reference will or may always be made interchangeably in respect of the disclosure of individual aspects of the invention.

Further advantages, features and details of the invention may be found in the following description, in which exemplary embodiments of the invention are described in detail with reference to the drawings. In this case, the features mentioned in the claims and in the description may respectively be essential to embodiments of the invention individually per se or in any desired combination. Insofar as the term “may” is used in this application, this refers both to the technical possibility and to the actual technical implementation.

Exemplary embodiments will be explained below with the aid of the appended drawings.

### BRIEF DESCRIPTION OF THE DRAWINGS lamp body.

FIGS. 1A-1D show an exemplary process sequence for the production of a

FIG. 2 shows an exemplary tool for carrying out the method.

FIG. 3 shows the tool head of the tool of FIG. 2.

### DETAILED DESCRIPTION OF THE DRAWINGS

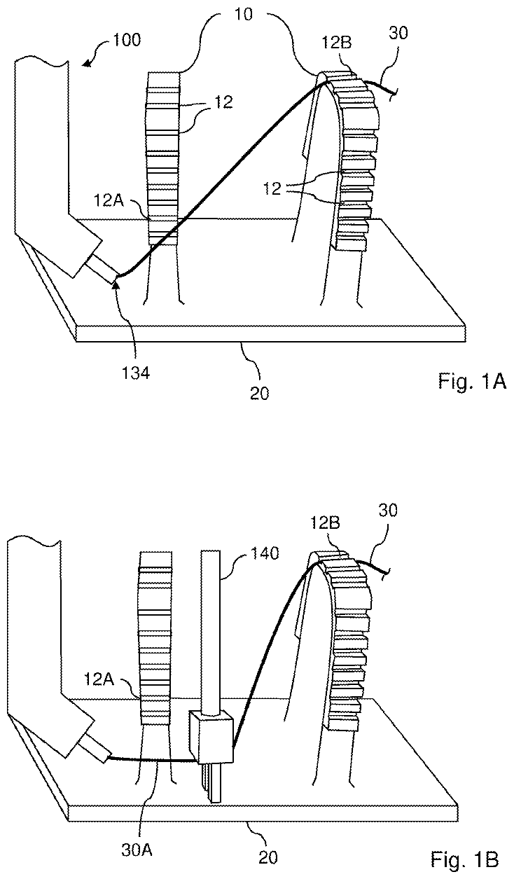

In order to produce the lamp body, a carrying structure 10 is initially provided. In FIGS. 1A to 1D, the carrying structure 10 comprises by way of example two individual elements, which are positioned on an auxiliary piece 20. Of course, the carrying structure 10 may also comprise more elements or even be configured integrally. In order to produce a three-dimensional optical waveguide sculpture, an optical waveguide 30 is intended to be wound onto the carrying structure 10. The carrying structure 10 comprises a plurality of reception grooves 12, in which the optical waveguide 30 may be placed and which are used for local fixing of the optical waveguide.

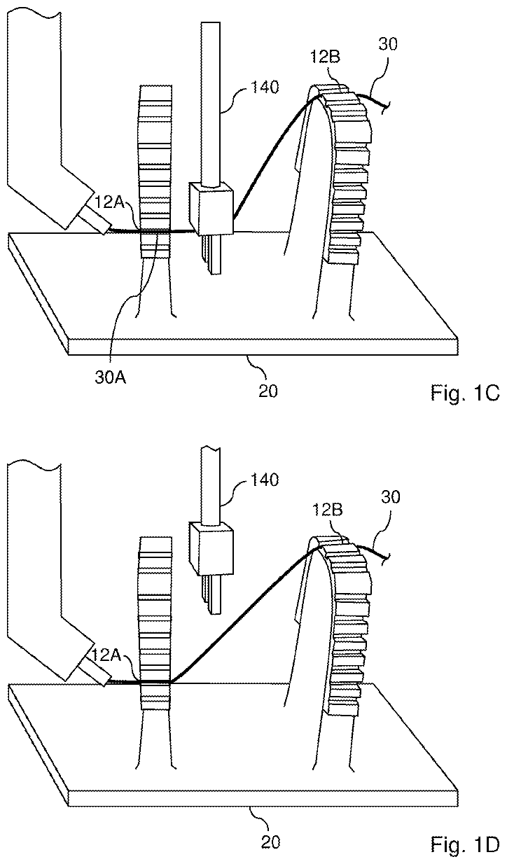

The optical waveguide 30 is provided by a tool 100, which will be explained in more detail with reference to FIG. 2. In this case, the optical waveguide 30 emerges from an optical waveguide exit opening 134 in the tool 100. Initially, the free end of the optical waveguide 30 is fixed in a fixing device (not represented) or fastened in another way on the carrying structure 10. The optical waveguide 30 initially extends from the fixing device to the optical waveguide exit opening 134, and is kept tensioned by the tool 100. The tool 100 then travels successively over the plurality of reception grooves 12 and threads the optical waveguide 30 into the reception grooves 12. The order in which the reception grooves 12 are travelled over is defined in such a way that the optical waveguide 30 is deposited on the carrying structure 10 with the desired three-dimensional profile.

The threading onto the reception grooves 12 is carried out in detail by the following measures, and is represented for one reception groove by way of example in FIGS. 1A to 1D.

The optical waveguide exit opening 134 is moved into the vicinity of the reception groove 12A into which the optical waveguide is intended to be inserted next. The optical waveguide 30 is tensioned between the optical waveguide exit opening 134 and the reception groove 12B approached last, see FIG. 1A. A positioning element 140 moves into the path of the optical waveguide 30, contacts the latter and displaces it in such a way that an optical waveguide section 30A is arranged between the optical waveguide exit opening 134 and the positioning element 140, substantially parallel to the profile of the reception groove 12A to be approached next, see FIG. 1B. The optical waveguide section 30A aligned in this way is then threaded into the corresponding reception groove 12A by moving the tool head 110, FIG. 1C. The positioning element 140 moves back and releases the optical waveguide 30. The optical waveguide 30 is kept under tension by the tool 100 and is now tensioned between the two reception grooves 12A and 12B.

These steps are repeated for the further reception grooves 12 until the optical waveguide 30 has been wound in the desired shape onto the carrying structure 10.

The optical waveguide 30 may then be separated and the end section may, for example, be fixed on the last reception groove or by way of a separate fixing device.

In the example shown in FIGS. 1A to 1D, subsequent to the winding of the optical waveguide 30, a carrying counter-structure (not represented) is put onto the carrying structure. The carrying counter-structure connects the individual elements of the carrying structure 10 to one another and may, for example, position them in a fixed fashion in relation to one another. Furthermore, the carrying counter-structure may close the groove opening of the reception grooves 12.

The lamp body produced in this way may be removed from the auxiliary piece 20 and, for example, arranged together with a light source, for example a laser or an LED, optionally along with optics in a lamp housing to form a vehicle lamp.

FIG. 2 shows a schematic representation of an exemplary tool 100 for carrying out the method. The tool 100 contains a tool head 110, which is fastened on a multiaxial industrial robot 120. The tool 100 furthermore contains an optical waveguide provision device 130, which guides the optical waveguide 30 from a stock roll 132 to the tool head 110, where it emerges from an optical waveguide exit opening 134. The optical waveguide 30 is guided by the optical waveguide provision device 130, preferably under tension, so that it can be drawn out from the optical waveguide exit opening 134 with a defined drawing force. A positioning element 140 is furthermore arranged on the tool head 110.

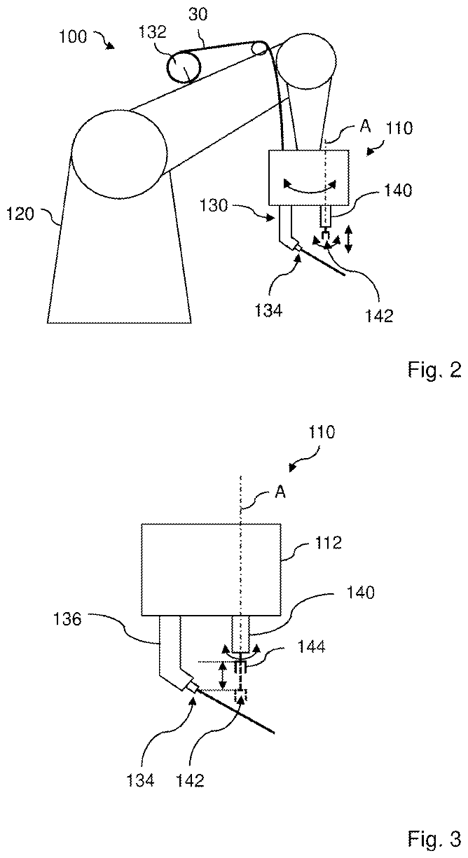

FIG. 3 shows the tool head 110 in an enlarged representation. The tool head 110 comprises a base body 112 as well as the optical waveguide exit opening 134 arranged in a fixed position thereon. The optical waveguide exit opening 134 is arranged at the end of a finger-shaped element 136. The positioning element 140 is furthermore arranged on the base body 112. At its free end, the positioning element 140 comprises an optical waveguide guide surface 142, which is brought to bear with the optical waveguide 30 during the method. The optical waveguide guide surface 142 is arranged between two guide bars 144 arranged in the shape of a fork, which guides the optical waveguide 30 during the forward displacement of the positioning element 140 toward the optical waveguide guide surface 142. In FIGS. 2 and 3, the guide bars 144 are aligned parallel to one another, although they may alternatively also converge toward one another, for example in a V-shape, and end at a common point of intersection in the guide surface 142.

The positioning element 140 is configured to be displaceable along an axis A, which extends at a distance from the optical waveguide exit opening 134. The positioning element 140 is displaceable in such a way that its optical waveguide guide surface 142 can be moved away from the base body 110 at least as far as the height of the optical waveguide exit opening 134, see the dashed representation of the positioning element 140 in FIG. 3.

The positioning element 140 is furthermore configured to be rotatable about the axis A. In this way, the position of the guide bars 144 can be matched to the profile of the optical waveguide 30 and secure optical waveguide guiding can be ensured.

Owing to the arrangement of the tool head 110 on an industrial robot 120, multiaxial movement and positioning of the optical waveguide exit opening 134 and of the positioning element 140 relative to the carrying structure 10 is possible. The method is preferably carried out by way of the tool 100 as an automated method.

### LIST OF REFERENCES

10 carrying structure

12, 12A, 12B reception grooves

20 auxiliary piece

30 optical waveguide

30A optical waveguide section

100 tool

110 tool head

112 base body

120 industrial robot

130 optical waveguide provision device

134 optical waveguide exit opening

136 finger-shaped element

140 positioning element

142 optical waveguide guide surface

144 guide bars

A axis

1.-7. (canceled)

8. A tool for producing a lamp body, the tool comprising:
a tool head with an optical waveguide exit opening,
an optical waveguide provision device for providing an optical waveguide at the optical waveguide exit opening, and
a positioning element which has an optical waveguide guide surface and is displaceable along an axis which extends at a distance from the optical waveguide exit opening.

9. The tool according to claim 8, wherein
the tool head is arranged on a multiaxial industrial robot.

10. The tool according to claim 8, wherein
the positioning element is configured to be rotatable about the axis.

11. The tool according to claim 8, wherein
the positioning element is configured at a free end in a shape of a fork with two guide bars, between which the optical waveguide guide surface is arranged.

12. The tool according to claim 8, wherein
the optical waveguide exit opening is arranged at a free end of a finger-shaped element.

13. A method for producing a lamp body, the method comprising:
providing a carrying structure with reception grooves, and
winding an optical waveguide around the carrying structure, for which purpose the optical waveguide is placed successively in the reception grooves according to a planned optical waveguide profile, the placement in the reception grooves comprising:
tensioning the optical waveguide between the reception groove approached last and an optical waveguide exit opening of the tool,
introducing a positioning element into a path of the optical waveguide, and displacing the optical waveguide such that an optical waveguide section that is arranged between the positioning element and the optical waveguide exit opening is aligned in a predetermined setting relative to the next reception groove,
placing the optical waveguide section in the next reception groove by moving the positioning element and the optical waveguide exit opening while maintaining a relative setting with respect to one another, and
removing the positioning element from the optical waveguide.

14. The method according to claim 13, wherein
the method is carried out in an automated fashion.
